(19) United States
(12) Patent Application Publication
(10) Pub. No.: US 2019/0294346 A1
(43) Pub. Date: Sep. 26, 2019

(54) LIMITING SIMULTANEOUS FAILURE OF MULTIPLE STORAGE DEVICES

(71) Applicant: INTERNATIONAL BUSINESS MACHINES CORPORATION, Armonk, NY (US)

(72) Inventors: Zah Barzik, Rishon LeZion (IL); Ramy Buechler, TEL AVIV (IL); Maxim Kalaev, Petach Tikva (IL); Michael Keller, Zurich (CH); Amit Margalit, Hod-Hasharon (IL); Rivka Matosevich, Zichron-Ya'acov (IL)

(21) Appl. No.: 15/935,266

(22) Filed: Mar. 26, 2018

(51) Int. Cl. G06F 3/06; G06F 11/07

(52) U.S. Cl. CPC G06F 3/0616; G06F 11/0727; G06F 3/0683; G06F 11/0787; G06F 3/0631; G06F 11/0751

(57) ABSTRACT

A data handling system includes multiple storage devices that each have a limited number of write and erase iterations. In one scheme, a deterministic endurance delta is created between a storage device (benchmark storage device), and the other storage devices so that the benchmark storage device has less endurance than the other storage devices. The benchmark storage device will likely reach endurance failure prior to the other storage devices and the probability of non-simultaneous endurance failure increases. In another scheme, a deterministic endurance delta is created between each of the storage devices so that each of the storage devices have a different endurance level than the other storage devices. By implementing the endurance delta simultaneous endurance failures of the storage devices may be avoided.

### FIELD OF THE INVENTION

Embodiments of the invention generally relate to data handling systems and more particularly to mitigating a risk of simultaneous failure of multiple storage devices.

### DESCRIPTION OF THE RELATED ART

In data handling systems that use solid state storage devices, or other storage devices, that have a limited number of write iterations, herein referred to as storage devices, there is a risk of the storage devices failing (i.e., reaching their endurance limit), in very tight temporal proximity. Simultaneous endurance failure could potentially lead to degraded input/output (I/O) performance and could even lead to a complete stop of I/O service to or from the endurance failed storage devices. The risk of simultaneous endurance failure is increased if the data handling system evenly distributes writes to the storage devices. Furthermore, if the data handing system attempts to maximize sequential writes to the storage devices, the probability of multiple storage devices reaching endurance failure simultaneously increases. Simultaneous storage device endurance failure may be especially relevant in newly-built data handing systems, since such systems typically include homogeneous storage devices that have the same relative endurance level.

### SUMMARY

In an embodiment of the present invention, a method of avoiding simultaneous endurance failure of a plurality of write limited storage devices within a storage system is presented. The method includes grouping a plurality of the write limited storage devices into an end of life (EOL) detection group. The method further includes provisioning storage space within each of the plurality of write limited storage devices in the EOL detection group such that each provisioned storage space is equal in size and comprises a storage portion that stores host data and a spare portion. The method further includes implementing a different endurance exhaustion rate of each write limited storage device by altering a size of each spare portion such that the size of each spare portion is different. The method further includes subsequently receiving host data and equally distributing the host data so that each of the plurality of the write limited storage devices in the EOL detection group store an equal amount of host data. The method further includes storing the host data that is distributed to each of the plurality of write limited storage devices in the EOL detection group within the respective storage portion of each write limited storage device. The method further includes detecting an endurance failure of the write limited storage device that comprises the smallest spare portion prior to an endurance failure of any other write limited storage devices in the EOL detection group.

In another embodiment of the present invention, a computer program product for avoiding simultaneous endurance failure of a plurality of write limited storage devices within a storage system is presented. The computer program product includes a computer readable storage medium having program instructions embodied therewith. The program instructions are readable to cause a processor of the storage system to group a plurality of the write limited storage devices into an end of life (EOL) detection group and provision storage space within each of the plurality of write limited storage devices in the EOL detection group such that each provisioned storage space is equal in size and comprises a storage portion that stores host data and a spare portion. The program instructions are further readable to cause a processor of the storage system to implement a different endurance exhaustion rate of each write limited storage device by altering a size of each spare portion such that the size of each spare portion is different and subsequently receive host data and equally distribute the host data so that each of the plurality of the write limited storage devices in the EOL detection group store an equal amount of host data. The program instructions are further readable to cause a processor of the storage system to store the host data that is distributed to each of the plurality of write limited storage devices in the EOL detection group within the respective storage portion of each write limited storage device and detect an endurance failure of the write limited storage device that comprises the smallest spare portion prior to an endurance failure of any other write limited storage devices in the EOL detection group.

In another embodiment of the present invention, a storage system includes a processor communicatively connected to a memory that comprises program instructions. The program instructions are readable by the processor to cause the storage system to group a plurality of the write limited storage devices into an end of life (EOL) detection group and provision storage space within each of the plurality of write limited storage devices in the EOL detection group such that each provisioned storage space is equal in size and comprises a storage portion that stores host data and a spare portion. The program instructions are further readable by the processor to cause the storage system to implement a different endurance exhaustion rate of each write limited storage device by altering a size of each spare portion such that the size of each spare portion is different and subsequently receive host data and equally distribute the host data so that each of the plurality of the write limited storage devices in the EOL detection group store an equal amount of host data. The program instructions are readable by the processor to further cause the storage system to store the host data that is distributed to each of the plurality of write limited storage devices in the EOL detection group within the respective storage portion of each write limited storage device and detect an endurance failure of the write limited storage device that comprises the smallest spare portion prior to an endurance failure of any other write limited storage devices in the EOL detection group.

These and other embodiments, features, aspects, and advantages will become better understood with reference to the following description, appended claims, and accompanying drawings.

### BRIEF DESCRIPTION OF THE DRAWINGS

FIG. 1 illustrates a high-level block diagram of an exemplary data handling system, such as a host computer, according to various embodiments of the invention.

FIG. 2 illustrates an exemplary storage system for implementing various embodiments of the invention.

FIG. 3 illustrates components of an exemplary storage system, according to various embodiments of the present invention.

FIG. 4 illustrates components of an exemplary storage system, according to various embodiments of the present invention.

FIG. 5 illustrates an exemplary embodiment of creating a deterministic endurance delta between storage devices of an exemplary storage system.

FIG. 6 illustrates an exemplary embodiment of creating a deterministic endurance delta between storage devices of an exemplary storage system.

FIG. 7 illustrates an exemplary embodiment of creating a deterministic endurance delta between storage devices of an exemplary storage system.

FIG. 8 illustrates an exemplary embodiment of creating a deterministic endurance delta between storage devices of an exemplary storage system.

FIG. 9 illustrates an exemplary embodiment of creating a deterministic endurance delta between storage devices of an exemplary storage system.

FIG. 10 illustrates an exemplary method of avoiding simultaneous endurance failure of a plurality of write limited storage devices within a storage system by creating a deterministic endurance delta between the storage devices by creating a deterministic endurance delta between storage devices of an exemplary storage system.

FIG. 11 illustrates an exemplary method of avoiding simultaneous endurance failure of a plurality of write limited storage devices within a storage system by creating a deterministic endurance delta between the storage devices by creating a deterministic endurance delta between storage devices of an exemplary storage system.

FIG. 12 illustrates an exemplary method of avoiding simultaneous endurance failure of a plurality of write limited storage devices within a storage system by creating a deterministic endurance delta between the storage devices by creating a deterministic endurance delta between storage devices of an exemplary storage system.

### DETAILED DESCRIPTION

A data handling system includes multiple storage devices that each have a limited number of write and erase iterations. In one scheme, a deterministic endurance delta is created between a storage device, herein referred to as a benchmark storage device, and the other storage devices so that the benchmark storage device has less endurance than the other storage devices. The benchmark storage device will likely reach endurance failure prior to the other storage devices and the probability of non-simultaneous endurance failure increases. In another scheme, a deterministic endurance delta is created between each of the storage devices so that each of the storage devices have a different endurance level than the other storage devices. Each of the storage devices will likely reach endurance failure at different time instances and the probability of non-simultaneous endurance failure increases.

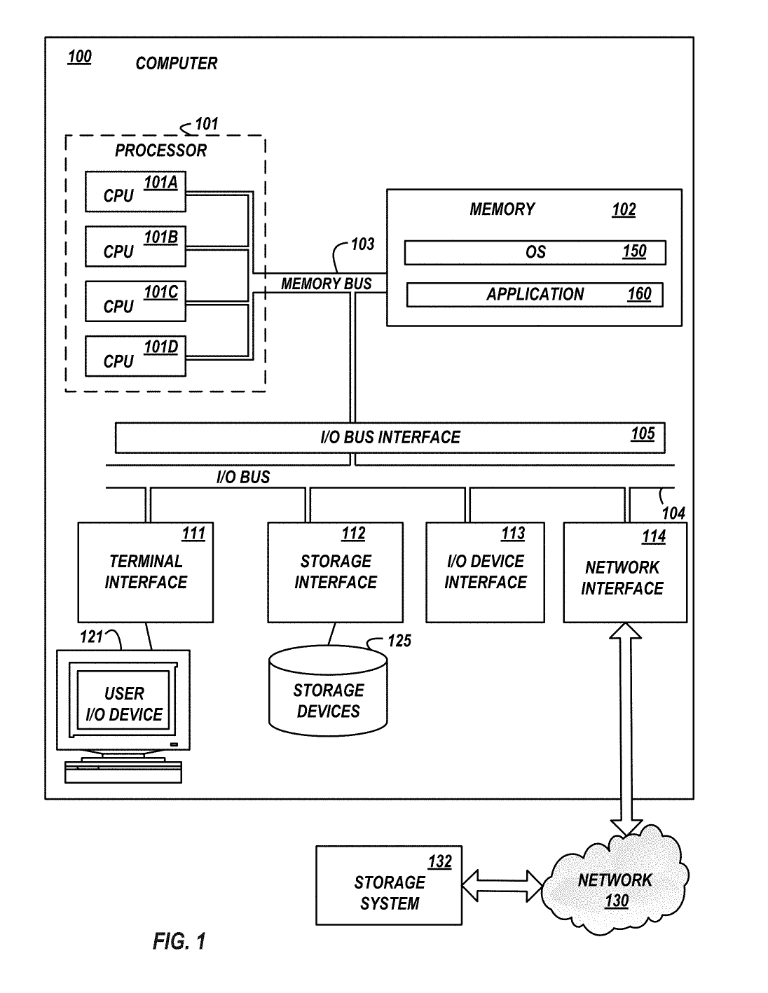

Referring to the Drawings, wherein like numbers denote like parts throughout the several views, FIG. 1 depicts a high-level block diagram representation of a host computer 100, which may simply be referred to herein as “computer” or “host,” connected to a storage system 132 via a network 130. The term “computer” or “host” is used herein for convenience only, and in various embodiments, is a general data handling system that stores data within and reads data from storage system 132. The mechanisms and apparatus of embodiments of the present invention apply equally to any appropriate data handling system.

The major components of the computer 100 may comprise one or more processors 101, a main memory 102, a terminal interface 111, a storage interface 112, an I/O (Input/Output) device interface 113, and a network interface 114, all of which are communicatively coupled, directly or indirectly, for inter-component communication via a memory bus 103, an I/O bus 104, and an I/O bus interface unit 105. The computer 100 contains one or more general-purpose programmable central processing units (CPUs) 101A, 101B, 101C, and 101D, herein generically referred to as the processor 101. In an embodiment, the computer 100 contains multiple processors typical of a relatively large system; however, in another embodiment the computer 100 may alternatively be a single CPU system. Each processor 101 executes instructions stored in the main memory 102 and may comprise one or more levels of on-board cache.

In an embodiment, the main memory 102 may comprise a random-access semiconductor memory, buffer, cache, or other storage medium for storing or encoding data and programs. In another embodiment, the main memory 102 represents the entire virtual memory of the computer 100 and may also include the virtual memory of other computer system (100A, 100B, etc.) (not shown) coupled to the computer 100 or connected via a network. The main memory 102 is conceptually a single monolithic entity, but in other embodiments the main memory 102 is a more complex arrangement, such as a hierarchy of caches and other memory devices. For example, memory 102 may exist in multiple levels of caches, and these caches may be further divided by function, so that one cache holds instructions while another holds non-instruction data, which is used by the processor or processors. Memory 102 may be further distributed and associated with different CPUs or sets of CPUs, as is known in any of various so-called non-uniform memory access (NUMA) computer architectures.

The main memory 102 stores or encodes an operating system 150, an application 160, and/or other program instructions. Although the operating system 150, an application 160, etc. are illustrated as being contained within the memory 102 in the computer 100, in other embodiments some or all of them may be on different computer systems and may be accessed remotely, e.g., via a network. The computer 100 may use virtual addressing mechanisms that allow the programs of the computer 100 to behave as if they only have access to a large, single storage entity instead of access to multiple, smaller storage entities.

Thus, while operating system 150, application 160, or other program instructions are illustrated as being contained within the main memory 102, these elements are not necessarily all completely contained in the same memory at the same time. Further, although operating system 150, an application 160, other program instructions, etc. are illustrated as being separate entities, in other embodiments some of them, portions of some of them, or all of them may be packaged together.

In an embodiment, operating system 150, an application 160, and/or other program instructions comprise instructions or statements that execute on the processor 101 or instructions or statements that are interpreted by instructions or statements that execute on the processor 101, to write data to and read data from storage system 132.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The I/O interface units support communication with a variety of storage and I/O devices. For example, the terminal interface unit 111 supports the attachment of one or more user I/O devices 121, which may comprise user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 121 and the computer 100 and may receive output data via the user output devices. For example, a user interface may be presented via the user I/O device 121, such as displayed on a display device, played via a speaker, or printed via a printer.

The storage interface unit 112 supports the attachment of one or more local disk drives or one or more local storage devices 125. In an embodiment, the storage devices 125 are rotating magnetic disk drive storage devices, but in other embodiments they are arrays of disk drives configured to appear as a single large storage device to a host computer, or any other type of storage device. The contents of the main memory 102, or any portion thereof, may be stored to and retrieved from the storage device 125, as needed. The local storage devices 125 have a slower access time than does the memory 102, meaning that the time needed to read and/or write data from/to the memory 102 is less than the time needed to read and/or write data from/to for the local storage devices 125.

The I/O device interface unit 113 provides an interface to any of various other input/output devices or devices of other types, such as printers or fax machines. For example, the storage system 132 may be connected to computer 100 via I/O device interface 113 by a cable, or the like.

The network interface unit 114 provides one or more communications paths from the computer 100 to other data handling devices, such as storage system 132. Such paths may comprise, e.g., one or more networks 130. Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 105 and the I/O bus 104 are shown as single respective units, the computer 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all the I/O devices are connected directly to one or more system I/O buses.

I/O interface unit 113 and/or network interface 114 may contain electronic components and logic to adapt or convert data of one protocol on I/O bus 104 to another protocol on another bus. Therefore, I/O interface unit 113 and/or network interface 114 may connect a wide variety of devices to computer 100 and to each other such as, but not limited to, tape drives, optical drives, printers, disk controllers, other bus adapters, PCI adapters, workstations using one or more protocols including, but not limited to, Token Ring, Gigabyte Ethernet, Ethernet, Fibre Channel, SSA, Fiber Channel Arbitrated Loop (FCAL), Serial SCSI, Ultra3 SCSI, Infiniband, FDDI, ATM, 1394, ESCON, wireless relays, Twinax, LAN connections, WAN connections, high performance graphics, etc.

Though shown as distinct entities, the multiple I/O interface units 111, 112, 113, and 114 or the functionality of the I/O interface units 111, 112, 113, and 114 may be integrated into a similar device.

In various embodiments, the computer 100 is a multi-user mainframe computer system, a single-user system, a server computer or similar device that has little or no direct user interface but receives requests from other computer systems (clients). In other embodiments, the computer 100 is implemented as a desktop computer, portable computer, laptop or notebook computer, tablet computer, pocket computer, telephone, smart phone, pager, automobile, teleconferencing system, appliance, or any other appropriate type of electronic device.

In some embodiments, network 130 may be a communication network that connects the computer 100 to storage system 132 and be any suitable communication network or combination of networks and may support any appropriate protocol suitable for communication of data and/or code to/from the computer 100. In various embodiments, the communication network may represent a data handling device or a combination of data handling devices, either connected directly or indirectly to the computer 100 and storage system 132. In another embodiment, the communication network may support wireless communications. In another embodiment, the communication network may support hard-wired communications, such as a telephone line or cable. In another embodiment, the communication network may be the Internet and may support IP (Internet Protocol). In another embodiment, the communication network is implemented as a local area network (LAN) or a wide area network (WAN). In another embodiment, the communication network is implemented as a hotspot service provider network. In another embodiment, the communication network is implemented an intranet. In another embodiment, the communication network is implemented as any appropriate cellular data network, cell-based radio network technology, or wireless network. In another embodiment, the communication network is implemented as any suitable network or combination of networks.

In some embodiments, network 132 may be a is a storage network, such as a storage area network (SAN), which is a network which provides access to consolidated, block level data storage. Network 130 is generally any high-performance network whose primary purpose is to enable storage system 132 to provide storage operations to computer 100. Network 130 may be primarily used to enhance storage devices, such as disk arrays, tape libraries, optical jukeboxes, etc., within the storage system 132 to be accessible to computer 100 so that the devices appear to the operating system 150 as locally attached devices. In other words, the storage system 132 may appear to the OS 150 as being storage device 125. A potential benefit of network 130 is that raw storage is treated as a pool of resources that can be centrally managed and allocated on an as-needed basis. Further, network 130 may be highly scalable because additional storage capacity can be added as required.

Network 130 may include may include multiple storage systems 132. Application 160 and/or OS 150 of multiple computers 100 can be connected to multiple storage systems 132 via the network 130. For example, any application 160 and or OS 150 running on each computer 100 can access shared or distinct storage within storage system 132. When computer 100 wants to access a storage device within storage system 132 via the network 130, computer 100 sends out a access request for the storage device. Network 130 may further include cabling, host bus adapters (HBAs), and switches. Each switch and storage system 132 on the network 130 may be interconnected and the interconnections generally support bandwidth levels that can adequately handle peak data activities. Network 130 may be a Fibre Channel SAN, iSCSI SAN, or the like.

In an embodiment, the storage system 132 may comprise some or all of the elements of the computer 100 and/or additional elements not included in computer 100.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

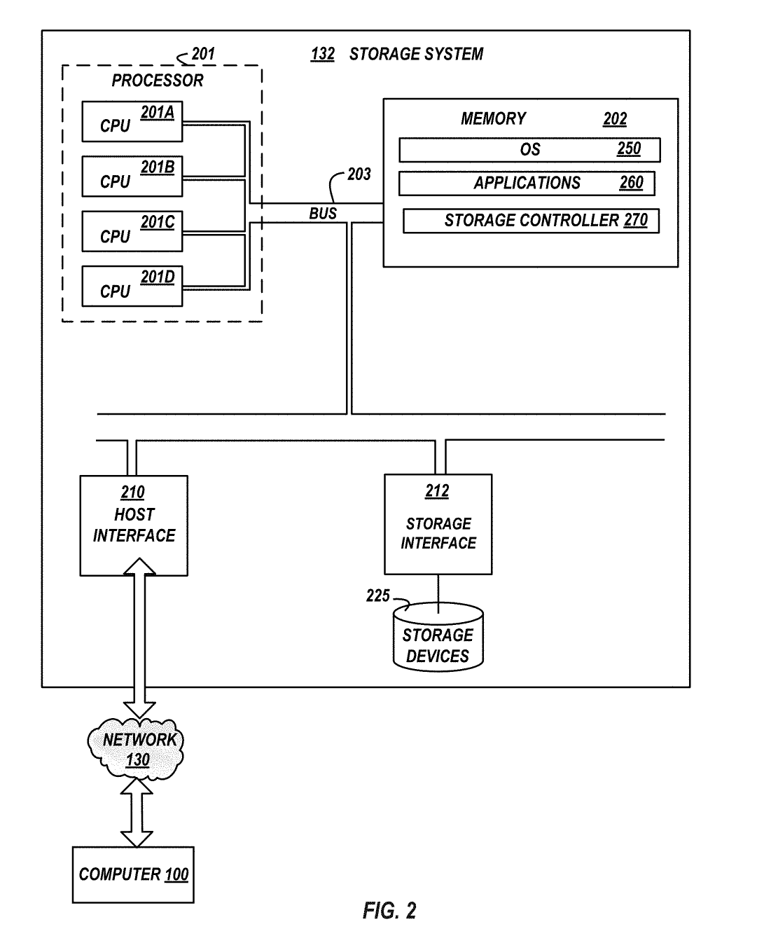

Referring to FIG. 2 that illustrates an exemplary storage system 132 connected to computer 100 via network 130. The term “storage system” is used herein for convenience only, and in various embodiments, is a general data handling system that receives, stores, and provides host data to and from computer 100. The mechanisms and apparatus of embodiments of the present invention apply equally to any appropriate data handling system.

The major components of the storage system 132 may comprise one or more processors 201, a main memory 202, a host interface 110 and a storage interface 112, all of which are communicatively coupled, directly or indirectly, for inter-component communication via bus 203. The storage system 132 contains one or more general-purpose programmable central processing units (CPUs) 201A, 201B, 201C, and 201D, herein generically referred to as the processor 201. In an embodiment, the storage system 132 contains multiple processors typical of a relatively large system; however, in another embodiment the storage system 132 may alternatively be a single CPU system. Each processor 201 executes instructions stored in the main memory 202 and may comprise one or more levels of on-board cache.

In an embodiment, the main memory 202 may comprise a random-access semiconductor memory, buffer, cache, or other storage medium for storing or encoding data and programs. In another embodiment, the main memory 202 represents the entire virtual memory of the storage system 132 and may also include the virtual memory of other storage system 132 (132A, 132B, etc.) (not shown) coupled to the storage system 132 or connected via a cable or network. The main memory 202 is conceptually a single monolithic entity, but in other embodiments the main memory 202 is a more complex arrangement, such as a hierarchy of caches and other memory devices. For example, memory 202 may exist in multiple levels of caches, and these caches may be further divided by function, so that one cache holds instructions while another holds non-instruction data, which is used by the processor or processors. Memory 202 may be further distributed and associated with different CPUs or sets of CPUs, as is known in any of various so-called non-uniform memory access (NUMA) computer architectures.

The main memory 202 stores or encodes an operating system 250 and an application 260, such as storage controller 270. Although the operating system 250, storage controller 270, etc. are illustrated as being contained within the memory 202 in the storage system 132, in other embodiments some or all of them may be on different storage system 132 and may be accessed remotely, e.g., via a cable or network. The storage system 132 may use virtual addressing mechanisms that allow the programs of the storage system 132 to behave as if they only have access to a large, single storage entity instead of access to multiple, smaller storage entities.

Thus, while operating system 250, storage controller 270, or other program instructions are illustrated as being contained within the main memory 202, these elements are not necessarily all completely contained in the same memory at the same time. Further, although operating system 250 and storage controller 270 are illustrated as being separate entities, in other embodiments some of them, portions of some of them, or all of them may be packaged together.

In an embodiment, operating system 250 and storage controller 270, etc., contain program instructions that comprise instructions or statements that execute on the processor 201 or instructions or statements that are interpreted by instructions or statements that execute on the processor 201, to write data received from computer 100 to storage devices 225 and read data from storage devices 225 and provide such data to computer 100.

Storage controller 270 is an application that provides I/O to and from storage system 132 and is logically located between computer 100 and storage devices 225, that presents itself to computer 100 as a storage provider (target) and presents itself to storage devices 225 as one big host (initiator). Storage controller 270 may include a memory controller and/or a disk array controller.

The bus 203 provides a data communication path for transferring data among the processor 201, the main memory 202, host interface 210, and the storage interface 212. Host interface 210 and the storage interface 212 support communication with a variety of storage devices 225 and host computers 100. The storage interface unit 212 supports the attachment of multiple storage devices 225. The storage devices 225 are storage devices that have a limited number of write and erase iterations. For example, storage devices 225 are SSDs. The storage devices 225 may be configured to appear as a single large storage device to host computer 100.

The host interface unit 210 provides an interface to a host computer 100. For example, the storage system 132 may be connected to computer 100 via host interface unit 210 by a cable, or network 132, or the like. Host interface unit 210 provides one or more communications paths from storage system 132 to the computer 100. Such paths may comprise, e.g., one or more networks 130. Although the bus 203 is shown in FIG. 2 as a relatively simple, single bus structure providing a direct communication path among the processors 201, the main memory 202, host interface 210, and storage interface 212, in fact the bus 203 may comprise multiple different buses or communication paths, which may be arranged in any of various forms, such as point-to-point links in hierarchical, star or web configurations, multiple hierarchical buses, parallel and redundant paths, or any other appropriate type of configuration.

Host interface 210 and/or storage interface 212 may contain electronic components and logic to adapt or convert data of one protocol on bus 203 to another protocol. Therefore, host interface 210 and storage interface 212 may connect a wide variety of devices to storage system 132. Though shown as distinct entities, the host interface 210 and storage interface 212 may be integrated into a same logical package or device.

FIG. 1 and FIG. 2 are intended to depict representative major components of the computer 100 and storage system 132. Individual components may have greater complexity than represented in FIG. 1 and/or FIG. 2, components other than or in addition to those shown in FIG. 1 and/or FIG. 2 may be present, and the number, type, and configuration of such components may vary. Several examples of such additional complexity or additional variations are disclosed herein; these are by way of example only and are not necessarily the only such variations. The various program instructions implementing e.g. upon computer system 100 and/or storage system 132 according to various embodiments of the invention may be implemented in a number of manners, including using various computer applications, routines, components, programs, objects, modules, data structures, etc., and are referred to hereinafter as “computer programs, “or simply “programs.”

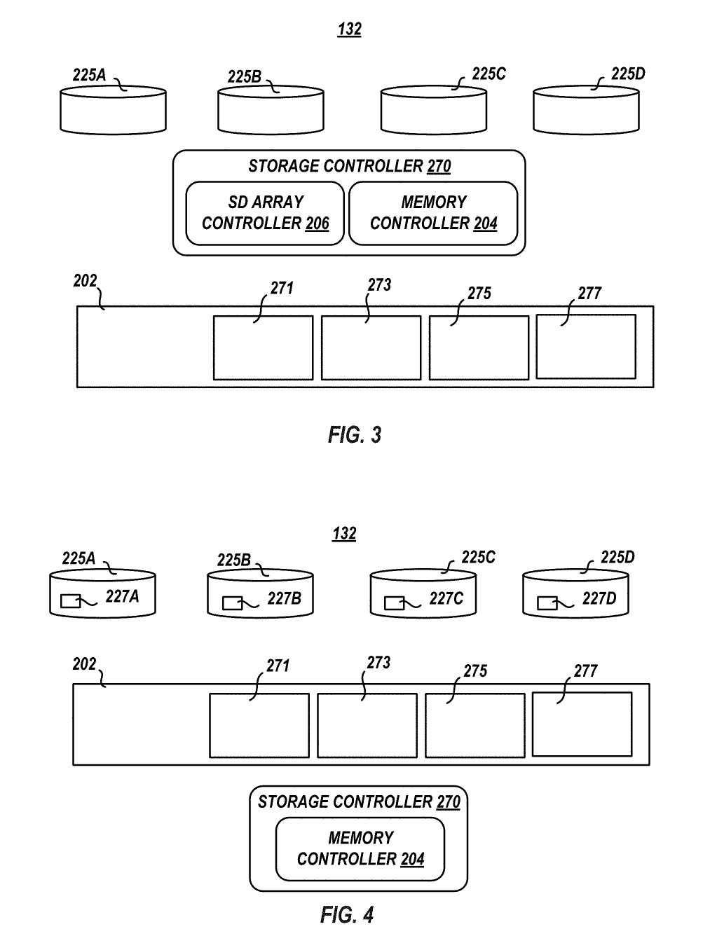

FIG. 3 illustrates components of storage system 132, according to an embodiment of the present invention. In the illustrated example, storage system 132 includes multiple storage devices 225a, 225b, 225c, and 225d. In the illustrated example, storage system 132 also includes a provisioned memory 202 that includes portion 271, 273, 275, and 277. In the illustrated example, storage controller 270 includes at least a storage device array controller 206 and a memory controller 204.

Storage controller 270 provisions memory 202 space. For example, memory controller 204 provisions memory 202 space into subsegments such as portion 271, 273, 275, and 277. Memory controller 204 may provision memory 202 space by provisioning certain memory addresses to delineate the memory portion 271, 273, 275, and 277. Storage controller 270 also allocates one or more provisioned memory portions to a storage device 225, or visa versa. For example, storage array controller 206 allocates storage device 225a to memory portion 271, allocates storage device 225b to memory portion 273, allocates storage device 225c to memory portion 275, and allocates storage device 225d to memory portion 277. In this manner, data cached in memory portion 271 is offloaded to the allocated storage device 225a, and the like. Storage controller 270 may allocate memory 202 space by allocating the provisioned memory addresses to the associated storage device 225. Storage controller 270 may also provide known storage system functionality such as data mirroring, backup, or the like.

Storage controller 270 conducts data I/O to and from computer 100. For example, during a computer 100 write to storage system 132, processor 101 provides host data associated with a host address, that processor 101 perceives as an address that is local to computer 100, to storage system 132. Memory controller 204 may receive the host data and host address and stores the host data within memory 202 at a memory location. Memory controller 204 may associate the memory address to the host address within a memory data structure, such as a table, map, or the like that it may also store in memory 202 and/or in a storage device 225. Subsequently, the host data may be offloaded from memory 202 to a storage device 225 by storage device array controller 206. The storage device array controller 206 may store the host data within the storage device 225 at a storage device address. Storage device array controller 206 may associate the memory address and/or the host address to the storage device address within a storage device data structure, such as a table, map, or the like that it may also stores in memory 202 and/or in a storage device 225.

During a computer 100 read from storage system 132, memory controller 204 may receive the host address from computer 100 and may determine if the host data is local to memory 202 by querying the memory data structure. If the host data is local to memory 202, memory controller 204 may obtain the host data at the memory address and may provide the host data to computer 100. If the host data is not local to memory 202, memory controller 204 may request the host data from the storage device array controller 206. Storage device array controller 206 may receive the host address and/or the memory address and may determine the storage device address of the requested host data by querying the storage device data structure. The storage device array controller 206 may retrieve the host data from the applicable storage device 225 at the storage location and may return the retrieved host data to memory 202, wherein in turn, memory controller 206 may provide the host data from memory 202 to computer 100. Host data may be generally organized in a readable/writeable data structure such as a block, volume, file, or the like.

As the storage devices 225 are write limited, the storage devices 225 have a finite lifetime dictated by the number of write operations known as program/erase (P/E) cycles that their respective flash storage mediums can endure. The endurance limit, also known as the P/E limit, or the like, of storage devices 225 is a quantifiable number that provides quantitative guidance on the anticipated lifespan of a storage device 225 in operation. The endurance limit of the storage device 225 may take into account the specifications of the flash storage medium of the storage device 225 and the projected work pattern of the storage device 225 and are generally determined or quantified by the storage device 225 manufacturer.

If storage devices 225 are NAND flash devices, for example, they will erase in ‘blocks’ before writing to a page, as is known in the art. Such dynamic results in write amplification, where the data size written to the physical NAND storage medium is in fact five percent to one hundred percent larger than the size of the data that is intended to be written by computer 100. Write amplification is correlated to the nature of workload upon the storage device 225 and impacts storage device 225 endurance.

Storage controller 270 may implement techniques to improve storage device 225 endurance such as wear leveling and overprovisioning. Wear leveling ensures even wear of the storage medium across the storage device 225 by evenly distributing all write operations, thus resulting in increased endurance.

Storage controller 270 may further manage data stored on the storage devices 225 and may communicate with processor 201, with processor 101, etc. The controller 270 may format the memory devices 225 and ensure that the devices 225 are operating properly. Controller 270 may map out bad flash memory cell(s) and allocate spare cells to be substituted for future failed cells. The collection of the allocated spare cells in the storage device 225 generally make up the spare portion.

FIG. 4 illustrates components of an exemplary storage system, according to various embodiments of the present invention. In the illustrated example, storage system 132 includes multiple storage devices 225a, 225b, 225c, and 225d. In the illustrated example, storage system 132 also includes a provisioned memory 202 that includes portion 271, 273, 275, and 277. In the illustrated example, storage controller 270 includes at least a memory controller 204. In the illustrate example, storage device 225a includes a local storage device controller 227a, storage device 225b includes a local storage device controller 227b, storage device 225c includes a local storage device controller 227c, and storage device 225c includes a local storage device controller 227c.

Storage controller 270 may provision memory 202 space. Storage controller 270 may also allocate one or more provisioned memory portions to a storage device 225, or visa versa. For example, memory controller 204 may allocate storage device 225a to memory portion 271, may allocate storage device 225b to memory portion 273, may allocate storage device 225c to memory portion 275, and may allocate storage device 225d to memory portion 277. In this manner, data cached in memory portion 271 is offloaded by storage device controller 227a to the allocated storage device 225a, and the like. Memory controller 204 may allocate memory 202 space by allocating the provisioned memory addresses to the associated storage device 225.

Storage controller 270 may also conduct data I/O to and from computer 100. For example, during a computer 100 write to storage system 132, processor 101 may provide host data associated with a host address, that processor 101 perceives as an address that is local to computer 100, to storage system 132. Memory controller 204 may receive the host data and host address and may store the host data within memory 202 at a memory location. Memory controller 204 may associate the memory address to the host address within a memory data structure, such as a table, map, or the like that it may also store in memory 202 and/or in a storage device 225. Subsequently, the host data may be offloaded from memory 202 to a storage device 225 by its associated storage device controller 227. The associated storage device controller 227 may store the host data within its storage device 225 at a storage device address. The applicable storage device controller 227 may associate the memory address and/or the host address to the storage device address within a storage device data structure, such as a table, map, or the like that it may also store in memory 202 and/or in its storage device 225.

During a computer 100 read from storage system 132, memory controller 204 may receive the host address from computer 100 and may determine if the host data is local to memory 202 by querying the memory data structure. If the host data is local to memory 202, memory controller 204 may obtain the host data at the memory address and may provide the host data to computer 100. If the host data is not local to memory 202, memory controller 204 may request the host data from the applicable storage device controller 227. The applicable storage device controller 227 may receive the host address and/or the memory address and may determine the storage device address of the requested host data by querying the storage device data structure. The applicable storage device controller 227 may retrieve the host data from its storage device 225 at the storage location and may return the retrieved host data to memory 202, wherein in turn, memory controller 206 may provide the host data from memory 202 to computer 100.

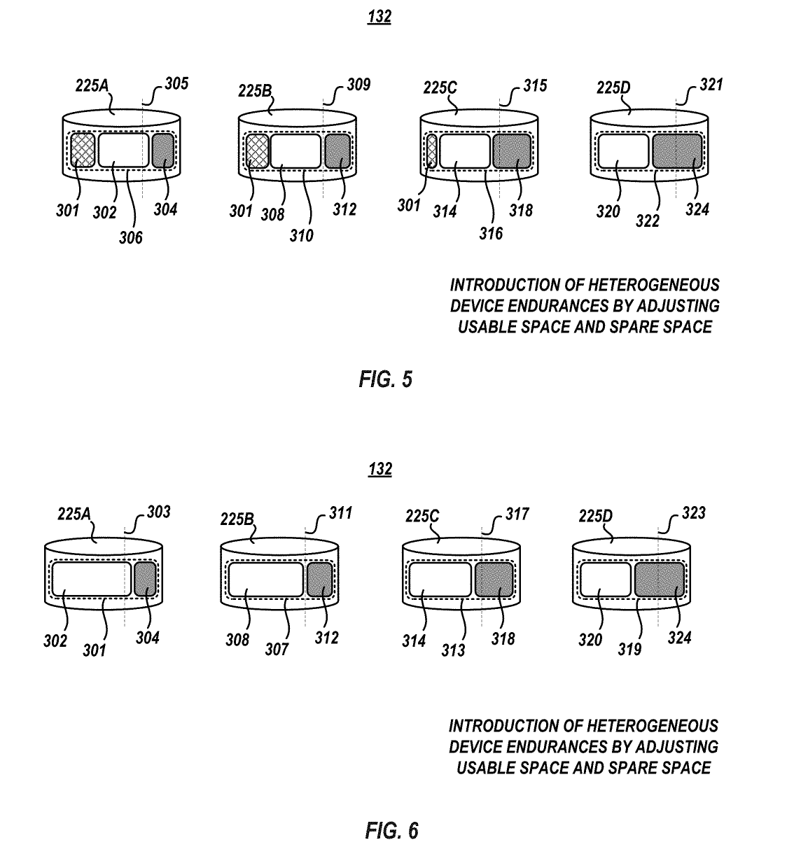

FIG. 5 illustrates an exemplary embodiment of creating a deterministic endurance delta between storage devices of an exemplary storage system. In the illustrated example, the storage devices 225a, 225b, 225c, and 225d may be grouped into an end of life (EOL) detection group by storage controller 270. A detectable endurance limit bias is created between at least one of the storage devices 225 in the EOL detection group. As such, at least one of the storage devices 225 will be expected to reach its endurance limit prior to the other storage devices 225 in the EOL detection group. This allows an early warning that the other storage device 225 in the EOL detection group may also soon be reaching their endurance limit.

According to one or more embodiments, a detectable endurance limit bias is created between at least one of the storage devices 225 in the EOL detection group by changing the size of a spare portion of the storage space on one storage device relative to the other storage devices 225 in the EOL detection group.

By changing the spare portion of at least one device 225 within the EOL detection group a different number of spare cells are available for use by that device 225 when cells in the storage space portion fail and need to be remapped. By setting one device 225 with a larger spare portion, the endurance of that device 225 is effectively increase compared to the other storage devices in the EOL detection group. On the other hand, by setting one device 225 with a smaller spare portion, the endurance of that device 225 is effectively decreased compared to the other storage devices 225 in the EOL detection group.

If each of the devices 225 in the EOL detection group receive the same or substantially the same number of writes (i.e., storage controller 270 implements an unbiased write arbitration scheme where devices 225a, 225b, 225c, and 225 are expected to have written the same amount of host data), the device 225 with an increased spare portion will have less of a storage portion that is used for storing host data. The increased ratio of spare portion to storage portion translates to a higher ratio of invalidated data sectors per erase-block and leads to lower write-amplification, so that the device with a greater spare portion may relocate less data to free up a new erase-block. This results in fewer overall P/E cycles in the storage device 225 with a larger spare portion and leads to slower exhaustion of that device's endurance limit.

By changing the size of the spare portion in at least one of the devices 225 in the EOL detection group, a more staggered failure pattern between the storage devices 225 in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. In other words, if the spare space of one storage device is smaller than all the other respective spare spaces of the other devices 225 in the EOL detection group, that storage device is expected to reach its endurance limit prior to the other storage devices 225 in the EOL detection group. This allows an early warning that the other storage device 225 in the EOL detection group may also soon be reaching their endurance limit.

In the illustrated example, each storage device 225a-225d are the same type of storage device with an initial preset ratio of the size of the storage portion to the size of the spare portion within an storage space. For instance, storage device 225a has a preset ratio 305 of the size of storage portion 302 that is utilized to store computer 100 host data to the size of spare portion 304 within storage space 306, storage device 225b has a preset ratio 309 of the size of storage portion 308 that is utilized to store computer 100 host data to the size of spare portion 312 within storage space 310, storage device 225c has a preset ratio 315 of the size of storage portion 314 that is utilized to store computer 100 host data to the size of spare portion 318 within storage space 316, and storage device 225d has a preset ratio 321 of the size of storage portion 320 that is utilized to store computer 100 host data to the size of spare portion 324 within storage space 322. In the illustrated example, the initial ratio 305, 309, 315, and 321 between the size of spare portion and the size of the storage portion are equal prior to changing the size of the spare portions relative to the all the other storage devices 225 in the EOL detection group.

Storage space 306 of device 225a is the actual physical storage size or amount of device 225a. Storage space 310 of device 225b is the actual physical storage size or amount of device 225b. Storage space 316 of device 225b is the actual physical storage size or amount of device 225c. Storage space 322 of device 225d is the actual physical storage size or amount of device 225d. In the embodiment depicted in FIG. 5, the storage portions 302, 308, 314, and 320 are the same size. Consequently, in some storage devices such as devices 225a, 225b, and 225c, storage spaces may include unused, blocked, or otherwise space that is not available for host access or spare processing, referred herein as unavailable space. For example, storage space 306, 310, and 316 each include unavailable space 301 there within.

In the illustrated example, a detectable endurance limit bias is created between each of the devices 225 in the EOL detection group by changing the size of a spare portion within the storage space of the storage devices 225 relative to the all the other storage devices 225 in the EOL detection group. Here for example, the size of spare portion 304 is reduced from a preset size associated with ratio 305, the size of spare portion 312 is maintained from a preset size associated with ratio 309, the size of spare portion 318 is increased from a present size associated with ratio 315, and the size of spare portion 324 is even further increased from a preset size associated with ratio 321.

By changing the spare portion 304, 312, 318, and 324 sizes of all the devices 225 within the EOL detection group, a different number of spare cells are available for use by the respective devices 225 when cells in the associated storage portion 302, 308, 314, and 320 fail and need to be remapped. By setting one device 225d in the EOL detection group with a largest size of its spare portion 324, the endurance of that device 225d is effectively increased compared to the other storage devices 225a, 225b, and 225c in the EOL detection group. On the other hand, by setting one device 225a with a smallest spare portion 304, the endurance of that device 225a is effectively decreased compared to the other storage devices 225b, 225c, and 225d in the EOL detection group.

If each of the devices 225 in the EOL detection group receive the same or substantially the same number of writes (i.e., storage controller 270 implements an unbiased write arbitration scheme where devices 225a, 225b, 225c, and 225 are expected to have stored the same amount of host data), the device 225d with the largest spare portion 324 will have the smallest storage portion 320 used for storing host data. The increased ratio of spare portion 324 to storage portion 320 translates to a higher ratio of invalidated data sectors per erase-block and leads to lower write-amplification, so that the device 225d that has the largest spare portion 324 may relocate less data to free up a new erase-block. This results in fewer overall P/E cycles in the storage device 225d with the largest spare portion 324 and leads to slower exhaustion of device 225d endurance limit.

On the other hand, the device 225a with the smallest spare portion 304 will have the largest storage portion 302 that is used for storing host data. The decreased ratio of spare portion 304 to storage portion 302 translates to a lower ratio of invalidated data sectors per erase-block and leads to higher write-amplification, so that the device 225a that has the smallest spare portion 304 may relocate more data to free up a new erase-block. This results in more overall P/E cycles in the storage device 225a with the smallest spare portion 304 and leads to more rapid exhaustion of device 225a endurance limit.

By staggering the size of the spare portions in all the devices 225 in the EOL detection group, a fully staggered failure pattern between the storage devices 225 in the EOL detection group is expected. The staggered failure of such devices 225 may allow an administrator to more efficiently manage device 225 replacement with less risk of catastrophic loss of data upon the storage devices 225 in the EOL detection group and less risk of all the storage devices 225 being unavailable for I/O. In other words, each storage device 225 is expected to reach its endurance limit at a different staggered instance compared to the other storage devices 225 in the EOL detection group. This allows an early warning that the other storage devices 225 in the EOL detection group may also soon be reaching their endurance limit.

Subsequent to staggering the size of the spare portions in all the devices 225 in the EOL detection group, storage system 132 may receive computer 100 data and may store such data within one or more storage devices 225 within the EOL detection group.

FIG. 6 illustrates an exemplary embodiment of creating a deterministic endurance delta between storage devices of an exemplary storage system. In the illustrated example, the storage devices 225a, 225b, 225c, and 225d may be grouped into an end of life (EOL) detection group by storage controller 270. A detectable endurance limit bias is created between at least one of the storage devices 225 in the EOL detection group. As such, at least one of the storage devices 225 will be expected to reach its endurance limit prior to the other storage devices 225 in the EOL detection group. This allows an early warning that the other storage device 225 in the EOL detection group may also soon be reaching their endurance limit.

According to one or more embodiments, a detectable endurance limit bias is created between at least one of the storage devices 225 in the EOL detection group by changing the size of a spare portion of provisioned storage space on one storage device relative to the other storage devices 225 in the EOL detection group.

By changing the spare portion of at least one device 225 within the EOL detection group a different number of spare cells are available for use by that device 225 when cells in the storage space portion fail and need to be remapped. By setting one device 225 with more a larger spare portion, the endurance of that device 225 is effectively increase compared to the other storage devices in the EOL detection group. On the other hand, by setting one device 225 with a smaller spare portion, the endurance of that device 225 is effectively decreased compared to the other storage devices 225 in the EOL detection group.

If each of the devices 225 in the EOL detection group receive the same or substantially the same number of writes (i.e., storage controller 270 implements an unbiased write arbitration scheme where devices 225a, 225b, 225c, and 225 are expected to have written the same amount of host data), the device 225 with an increased spare portion will have less of a storage portion that is used for storing host data. The increased ratio of spare portion to storage portion translates to a higher ratio of invalidated data sectors per erase-block and leads to lower write-amplification, so that the device with a greater spare portion may relocate less data to free up a new erase-block. This results in fewer overall P/E cycles in the storage device 225 with a larger spare portion and leads to slower exhaustion of that device's endurance limit.

By changing the size of the spare portion in at least one of the devices 225 in the EOL detection group, a more staggered failure pattern between the storage devices 225 in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. In other words, if the spare space of one storage device is smaller than all the other respective spare spaces of the other devices 225 in the EOL detection group, that storage device is expected to reach its endurance limit prior to the other storage devices 225 in the EOL detection group. This allows an early warning that the other storage device 225 in the EOL detection group may also soon be reaching their endurance limit.

In the illustrated example, each storage device 225a-225d are the same type of storage device with an initial preset ratio of the size of the storage portion to the size of the spare portion within the physical storage space of the device. For instance, storage device 225a has a preset ratio 303 of the size of storage portion 302 that is utilized to store computer 100 host data to the size of spare portion 304 within the physical storage space 301, storage device 225b has a preset ratio 311 of the size of storage portion 308 that is utilized to store computer 100 host data to the size of spare portion 312 within physical storage space 307, storage device 225c has a preset ratio 317 of the size of storage portion 314 that is utilized to store computer 100 host data to the size of spare portion 318 within physical storage space 313, and storage device 225d has a preset ratio 323 of the size of storage portion 320 that is utilized to store computer 100 host data to the size of spare portion 324 within physical storage space 319. In the illustrated example, the initial ratio 303, 311, 317, and 323 between the size of spare portion and the size of the storage portion are equal prior to changing the size of the spare portions relative to the all the other storage devices 225 in the EOL detection group.

The physical storage space 301 of device 225a is generally the actual physical storage size or amount of device 225a provisioned by storage controller 270. Similarly, storage space 310 of device 225b is generally the actual physical storage size or amount of device 225c provisioned by storage controller 270. Likewise, the storage space 316 of device 225c is generally the actual physical storage size or amount of device 225c provisioned by storage controller 270 and the storage space 322 of device 225d is generally the actual physical storage size or amount of device 225d provisioned by storage controller 270.

In the illustrated example, a detectable endurance limit bias is created between each of the devices 225 in the EOL detection group by changing the size of a spare portion within the physical storage space of the storage devices 225 relative to the all the other storage devices 225 in the EOL detection group. Here for example, the size of spare portion 304 is reduced from a preset size associated with ratio 303, the size of spare portion 312 is maintained from a preset size associated with ratio 311, the size of spare portion 318 is increased from a present size associated with ratio 317, and the size of spare portion 324 is even further increased from a preset size associated with ratio 323.

By changing the spare portion 304, 312, 318, and 324 sizes of all the devices 225 within the EOL detection group, a different number of spare cells are available for use by the respective devices 225 when cells in the associated storage portion 302, 308, 314, and 320 fail and need to be remapped. By setting one device 225d in the EOL detection group with a largest size of its spare portion 324, the endurance of that device 225d is effectively increase compared to the other storage devices 225a, 225b, and 225c in the EOL detection group. On the other hand, by setting one device 225a with a smallest spare portion 304, the endurance of that device 225a is effectively decreased compared to the other storage devices 225b, 225c, and 225d in the EOL detection group.

If each of the devices 225 in the EOL detection group receive the same or substantially the same number of writes (i.e., storage controller 270 implements an unbiased write arbitration scheme where devices 225a, 225b, 225c, and 225 are expected to have written the same amount of host data), the device 225d with the largest spare portion 324 will the smallest storage portion 320 that is used for storing host data. The increased ratio of spare portion 324 to storage portion 320 translates to a higher ratio of invalidated data sectors per erase-block and leads to lower write-amplification, so that the device 225d that has the largest spare portion 324 may relocate less data to free up a new erase-block. This results in fewer overall P/E cycles in the storage device 225d with the largest spare portion 324 and leads to slower exhaustion of device 225d endurance limit.

On the other hand, the device 225a with the smallest spare portion 304 will have the largest storage portion 302 that is used for storing host data. The decreased ratio of spare portion 304 to storage portion 302 translates to a lower ratio of invalidated data sectors per erase-block and leads to higher write-amplification, so that the device 225a that has the smallest spare portion 304 may relocate more data to free up a new erase-block. This results in more overall P/E cycles in the storage device 225a with the smallest spare portion 304 and leads to more rapid exhaustion of device 225a endurance limit.

By staggering the size of the spare portions in all the devices 225 in the EOL detection group, a fully staggered failure pattern between the storage devices 225 in the EOL detection group is expected. The staggered failure of such devices 225 may allow an administrator to more efficiently manage device 225 replacement with less risk of catastrophic loss of data upon the storage devices 225 in the EOL detection group and less risk of all the storage devices 225 being unavailable for I/O. In other words, each storage device 225 is expected to reach its endurance limit at a different staggered instance compared to the other storage devices 225 in the EOL detection group. This allows an early warning that the other storage devices 225 in the EOL detection group may also soon be reaching their endurance limit.

Subsequent to staggering the size of the spare portions in all the devices 225 in the EOL detection group, storage system 132 may receive computer 100 data and may store such data within one or more storage devices 225 within the EOL detection group.

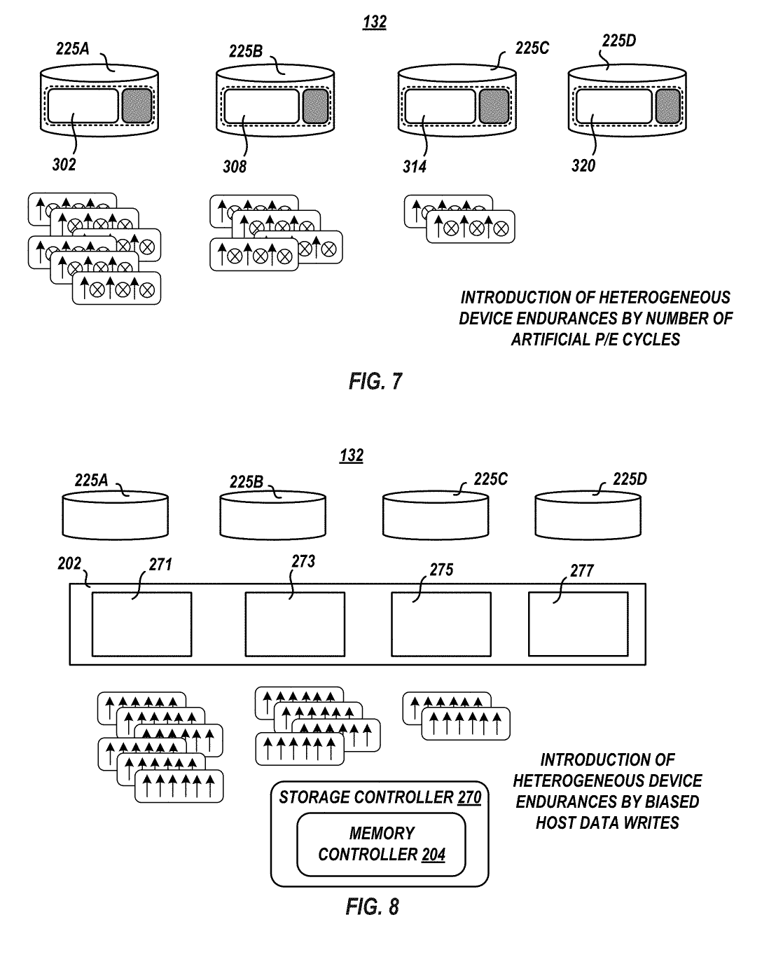

FIG. 7 illustrates an exemplary embodiment of creating a deterministic endurance delta between storage devices of an exemplary storage system. In the illustrated example, the storage devices 225a, 225b, 225c, and 225d may be grouped into an end of life (EOL) detection group by storage controller 270. A detectable endurance limit bias is created between at least one of the storage devices 225 in the EOL detection group. As such, at least one of the storage devices 225 will be expected to reach its endurance limit prior to the other storage devices 225 in the EOL detection group. This allows an early warning that the other storage device 225 in the EOL detection group may also soon be reaching their endurance limit.

According to one or more embodiments, a detectable endurance limit bias is created between at least one of the storage devices 225 in the EOL detection group by performing an increased number of P/E cycles upon one of the devices 225 relative to the other device 225 in the EOL detection group. For example, storage controller 270 includes two distinct patterns of data. The storage controller 270 controls the writing of the first pattern of data onto the storage portion or a part of the storage portion of device 225. That device 225 then conducts an erase procedure to erase the first pattern. Subsequently, the storage controller 270 controls the writing of the second pattern of data onto the storage portion or the part of the storage portion of the device 225 and the device then conducts an erase procedure to erase the second pattern. In other words, the device 225 is subjected to artificial P/E cycles (i.e. P/E cycles associated with non-host data), thus lowering the endurance of the device 225. When subject to these artificial P/E cycles, the device 225 may report its wear out level (using known techniques such as Self-Monitoring, Analysis, and Reporting Technology, or the like) to storage manager 270 so storage manager 270 may determine a calculated endurance limit for the device 225 utilizing the I/O operational statistics and the reported wear out level of the device 225.

The artificial P/E cycles are generally performed prior to the device 225 storing host data. As such, the device 225 begins its useful life in system 132 with several P/E cycles already performed and is likely to reach its endurance limit prior to the other devices 225 in the EOL detection group. In other words, by performing P/E cycles upon one device 225, the endurance of that device 225 is effectively decreased compared to the other storage devices 225 in the EOL detection group.

If each of the devices 225 in the EOL detection group receive the same or substantially the same number of writes (i.e., storage controller 270 implements an unbiased write arbitration scheme where devices 225a, 225b, 225c, and 225 are expected to have written the same amount of host data), the device 225 that had previous artificial P/E cycles performed therein results in a faster exhaustion of that device's endurance limit. As such, a more staggered failure pattern between the storage devices 225 in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. By artificially performing P/E cycles on one device 225 where such device will reach its endurance limit prior to the other devices 225 in the EOL detection group, an early warning is created to indicate that the other storage device 225 in the EOL detection group may also soon be reaching their endurance limit or end of life.

In the illustrated example, each storage device 225a-225d are the same type of storage device with the same ratio of the size of the storage portion to the size of the spare portion within the physical storage space of the device. For instance, the size of storage portion 302, 308, 314, and 320 are the same.

In the illustrated example, a detectable endurance limit bias is created between each of the devices 225 in the EOL detection group by changing the number of artificial P/E cycles that each device 225 in the EOL detection group are subject to. Here for example, a largest number of artificial P/E cycles are performed within storage space 302 of device 225a and a fewer number of largest number of artificial P/E cycles are performed within storage space 308 of device 225b. Similarly, a smallest number of artificial P/E cycles are performed within storage space 320 of device 225d and greater number of artificial P/E cycles are performed within storage space 314 of device 225c.

If each of the devices 225a, 225b, 225c, and 225d in the EOL detection group receive the same or substantially the same number of writes (i.e., storage controller 270 implements an unbiased write arbitration scheme where devices 225a, 225b, 225c, and 225 are expected to have written the same amount of host data), the device 225a that had the largest number artificial P/E cycles performed therein results in a fastest exhaustion of that device 225a endurance limit. Similarly, the device 225d that had the smallest number artificial P/E cycles performed therein results in a slowest exhaustion of that device 225d endurance limit. As such, a more staggered failure pattern between the storage devices 225a, 225b, 225c, and 225d in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. By artificially performing a different number of P/E cycles on each of the devices 225, an early cascading warning is created to indicate that another storage device 225 (e.g., the next device with the highest artificial P/E cycles performed thereupon) in the EOL detection group may also soon be reaching their endurance limit or end of life.

FIG. 8 illustrates an exemplary embodiment of creating a deterministic endurance delta between storage devices of an exemplary storage system. In the illustrated example, the storage devices 225a, 225b, 225c, and 225d may be grouped into an end of life (EOL) detection group by storage controller 270. A detectable endurance limit bias is created between at least one of the storage devices 225 in the EOL detection group. As such, at least one of the storage devices 225 will be expected to reach its endurance limit prior to the other storage devices 225 in the EOL detection group. This allows an early warning that the other storage device 225 in the EOL detection group may also soon be reaching their endurance limit.

According to one or more embodiments, a detectable endurance limit bias is created between at least one of the storage devices 225 in the EOL detection group by storage controller 270 biasing or preferentially performing host data writes to one or more devices 225. For example, storage controller 270 selects a particular storage device 225 and performs an extra host data write to that device 220 for every ten host host data writes to all of the storage devices 225 in the EOL detection group. In other words, after fairly arbitrating ten host data set writes to each storage devices 225 in the EOL detection group, the storage controller writes an extra host data set to the arbitration preferred device 225 so that this device has received eleven data writes and the other devices have received ten data writes, after fairly arbitrating fifty host data set writes to each storage devices 225 in the EOL detection group, the storage controller writes an extra host data set to the arbitration preferred device 225 so that this device has received fifty one data writes and the other devices have received fifty data writes, or the like.

The storage controller may bias host writes by biasing to which portion 271, 273, 275, or 277 host data is written. For example, to bias host data writes to device 225a memory controller 204 may bias host data to be cached or buffered within the portion 271 that is allocated to device 225a, to bias host data writes to device 225b memory controller 204 may bias host data to be cached or buffered within the portion 273 that is allocated to device 225b, or the like. In this manner, for example, memory portion 271 that memory controller 204 prefers in its biased write arbitration scheme would fill more quickly and, as such, the host data therein stored would be offloaded to the associated device 225a more quickly relative to the other memory portions 273, 275, and 277 and other devices 225b, 225c, and 225d, respectively.

As the arbitration preferred device 225 is subject to an increased amount of data writes relative to the other devices 225 in the EOL detection group, the arbitration preferred device 225 will have a lower endurance relative to the other devices 225 in the EOL detection group. As such, a more staggered failure pattern between the storage devices 225 in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. By storage controller 270 biasing writes to one device 225 where such device will reach its endurance limit prior to the other devices 225 in the EOL detection group, an early warning is created to indicate that the other storage device 225 in the EOL detection group may also soon be reaching their endurance limit or end of life.

In the illustrated example, a detectable endurance limit bias is created between each of the devices 225 in the EOL detection group by staggering how much each device 225 is preferred by storage controller 270 biasing host data writes. Here for example, storage controller 270 prefers device 225a the most and therefore selects such device the most when writing host data to any of the devices 225 in the EOL detection group while storage controller 270 prefers device 225d the least and therefore selects such device the least when writing host data to any of the devices 225 in the EOL detection group. Similarly, storage controller 270 prefers device 225b less than it prefers device 225a and therefore selects device 225b less than it selects device 225a when writing host data to any of the devices 225 in the EOL detection group while storage controller 270 prefers device 225c more than device 225d and therefore selects device 225c more than device 225d when writing host data to any of the devices 225 in the EOL detection group. In this manner a staggered number of host data writes may be performed upon sequential devices 225 in the EOL detection group.

The storage controller may stagger host writes to devices 225a, 225b, 225c, and 225d by biasing to which portion 271, 273, 275, or 277 host data is written. For example, for storage controller 270 to prefer device 225a the most, memory controller 204 writes the highest amount of host data to buffer 271. Similarly, for storage controller 270 to prefer device 225b less than device 225a, memory controller 204 may write less host data to buffer 273 relative to the amount of host data it writes to buffer 271. Likewise, for storage controller 270 to prefer device 225c less than device 225b, memory controller 204 may write less host data to buffer 275 relative to the amount of host data it writes to buffer 273. Likewise, for storage controller 270 to prefer device 225d less than device 225c, memory controller 204 may write less host data to buffer 277 relative to the amount of host data it writes to buffer 275.

As the host write arbitration scheme may be staggered across devices 225, a staggered amount of data is written across the devices 225 in the EOL detection group. As such, a staggered failure pattern between the storage devices 225 in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. The device 225a that had the largest number of host data writes results in a fastest exhaustion of that device 225a endurance limit. Similarly, the device 225d that had the smallest number host data writes performed thereon results in a slowest exhaustion of that device 225d endurance limit. As such, a more staggered failure pattern between the storage devices 225a, 225b, 225c, and 225d in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. By staggering the number of host data writes performed upon each of the devices 225, an early cascading warning is created to indicate that another storage device 225 (e.g., the next device with the highest number of host data writes performed thereupon) in the EOL detection group may also soon be reaching their endurance limit or end of life.

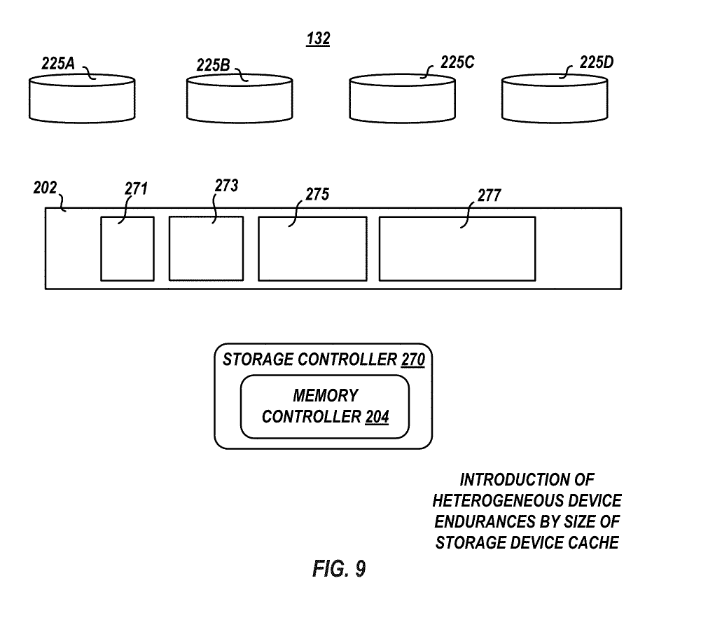

FIG. 9 illustrates an exemplary embodiment of creating a deterministic endurance delta between storage devices of an exemplary storage system. In the illustrated example, the storage devices 225a, 225b, 225c, and 225d may be grouped into an end of life (EOL) detection group by storage controller 270. A detectable endurance limit bias is created between at least one of the storage devices 225 in the EOL detection group. As such, at least one of the storage devices 225 will be expected to reach its endurance limit prior to the other storage devices 225 in the EOL detection group. This allows an early warning that the other storage device 225 in the EOL detection group may also soon be reaching their endurance limit.

According to one or more embodiments, a detectable endurance limit bias is created between at least one of the storage devices 225 in the EOL detection group by storage controller 270 allocating a different amount of storage space to one of the portions 271, 273, 275, and/or 277. For example, storage controller memory controller 204 selects a storage device 225a and allocates a smaller amount of memory 202 to portion 271 relative to other portions 273, 275, and 277. If storage controller 270 does not bias host data writes to any of the portions 271, 273, 275, or 277 and since portion 271 is smaller than the other memory portions, portion 271 fills more rapidly than the other portions and the data therein is offloaded more frequently its associated device 225a.

Different size portions 271, 273, 275, or 277 affect storage devices 225a, 225b, 225c, and 225d endurance by not writing first data that is within the portion 271, 273, 275, or 277, to a location within its assigned storage device 225a, 225b, 225c, and 225d when newer second data is to be written in the same location of its assigned device 225a, 225b, 225c, and 225d becomes cached in portion 271, 273, 275, or 277. Here, the first data need not be written to its storage device 225a, 225b, 225c, and 225d and the second data may be written in its stead. In other words, an unneeded write to the storage device is avoided by such strategic caching mechanisms. Thus, the larger the cache size the greater the probability that first data becomes stale while new second data enters the cache and may be subsequently written to that same location in the storage device in place of the stale first data.

As the device 225a is subject to a more frequent amount of these stale data writes relative to the other devices 225 in the EOL detection group, because of its smallest assigned portion 271, the device 225a may have a lower endurance relative to the other devices 225 in the EOL detection group. As such, a more staggered failure pattern between the storage devices 225 in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. By storage controller 270 allocating a different memory space to one portion 271, relative to the other portions 273, 275, and 277, an early warning is created upon the failure of device 225a to indicate that the other storage device 225b, 225c, and 225d in the EOL detection group may also soon be reaching their endurance limit or end of life.

In the illustrated example, a detectable endurance limit bias is created between each of the devices 225 in the EOL detection group by staggering the sizes of each portion 271, 273, 275, and 277. Here for example, memory controller 204 allocates a smallest number of memory space or address ranges as portion 271 that serves as a buffer to device 225a; allocates a larger number of memory space or address ranges, relative to portion 271, as portion 273 that serves as a buffer to device 225b; allocates a larger number of memory space or address ranges, relative to portion 273, as portion 275 that serves as a buffer to device 225c; and allocates a larger number of memory space or address ranges, relative to portion 275, as portion 277 that serves as a buffer to device 225d. As such, upon storage controller 270 equally biasing host data writes to each portion 271, 273, 275, and 277, portion 271 fills more rapidly than portions 273, 275, and 277.

By allocating less memory space to device 225a, the load of stale data writes is increased upon device 225a which leads to more P/E cycles performed thereupon and a faster exhaustion of device 225a's endurance limit. As the device 225a is subject to more frequent stale data writes relative to the other devices 225 in the EOL detection group, the device 225a has a lower endurance relative to the other devices 225 in the EOL detection group.

As such, some devices 225 experience more frequent stale data writes, a staggered failure pattern between the storage devices 225 in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. The device 225a that has the most stale data writes (i.e. memory portion 271 is the smallest) results in a fastest exhaustion of that device 225a endurance limit. Similarly, the device 225d that has the least stale data writes (i.e. memory portion 277 is the largest) results in a slowest exhaustion of that device 225d endurance limit. As such, a more staggered failure pattern between the storage devices 225a, 225b, 225c, and 225d in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. By staggering the size of memory portions 271, 273, 275, and 277 associated with respective devices 225a, 225b, 225c, and 225d, an early cascading warning is created to indicate that another storage device 225 (e.g., the device which is next most frequently loaded) in the EOL detection group may also soon be reaching their endurance limit or end of life.

For clarity, in FIG. 1 through FIG. 9 different embodiments are presented to create different endurance level(s) between at least one device 225 and the other devices 225 in an EOL detection group. Any one or more these embodiments may be combined as is necessary to create an increased delta of respective endurance level(s) between the at least one device 225 and the other devices 225 in the EOL endurance group. For example, the embodiment of staggering the size of the spare portion in one or more devices 225, shown in FIG. 5 or FIG. 6 may be combined with the embodiment of allocating a different size of memory space to one or more devices 225, as shown in FIG. 9.

In the embodiments where the endurance level of at least one of the devices 225 in the EOL is changed relative to the other devices 225 in the EOL detection group, such one device 225 may herein be referred to as the benchmark device 225. The endurance level of benchmark device 225 may be monitored to determine whether the endurance level reaches the endurance limit of the device 225. If the benchmark device 225 is replaced or otherwise removed from the EOL detection group, a new benchmark device 225 may be selected from the EOL detection group. For example, the device 225 that has had the greatest number of host data writes thereto may be selected as the new benchmark device which may be monitored to determine when the device reaches its end of life and to indicate that the other devices 225 in the EOL detection group may also soon reach their endurance limit. In another example, the device 225 that has been subject to the greatest number of P/E cycles may be selected as the new benchmark device which may be monitored to determine when the device reaches its end of life and to indicate that the other devices 225 in the EOL detection group may also soon reach their endurance limit.

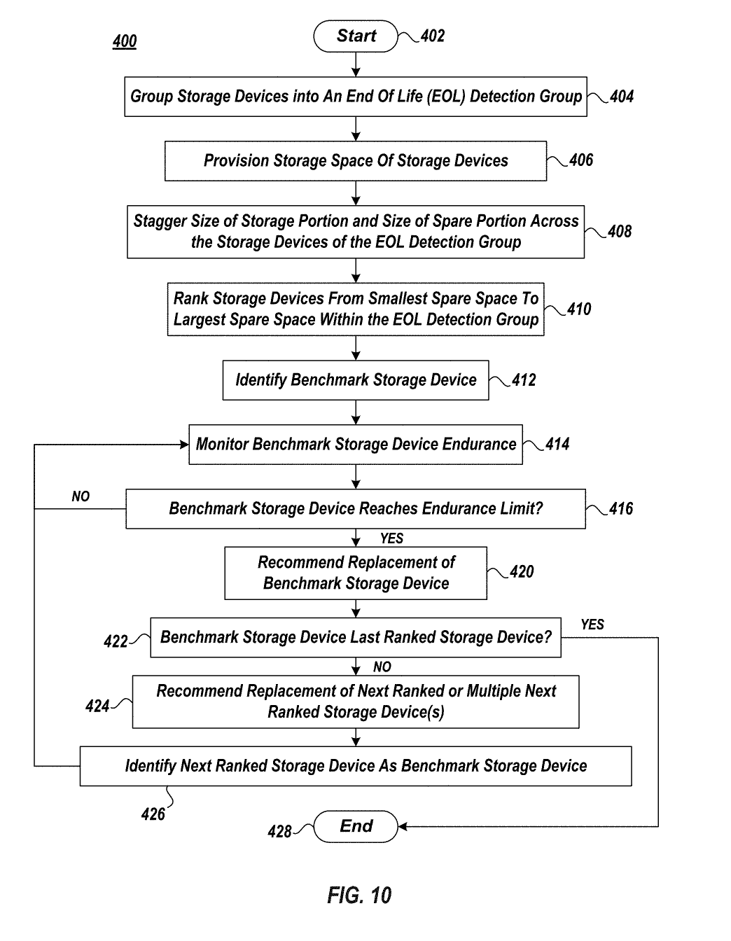

FIG. 10 illustrates an exemplary method 400 of avoiding simultaneous endurance failure of a plurality of write limited storage devices within a storage system by creating a deterministic endurance delta between the storage devices. Method 400 may be utilized by storage controller 270 such that when evoked by processor 201 may cause the storage system 132 to perform the indicated functionality. Method 400 begins at block 402 and continues with grouping multiple storage devices 225 into an EOL detection group (block 404). For example, if there are sixteen storage devices within system 132, storage controller 270 may create four EOL detection groups of four storage devices each.

Method 400 may continue with provisioning storage space of each storage device (block 406). For example, the controller 270 may provision storage space as the actual physical storage space of a device 225. Within the storage space the controller 270 may provision a storage portion and a spare portion. The storage portion is generally the collection of cells of the storage device 225 that store host data. The controller 270 may allocate spare cells to the spare portion to may be substituted for future failed cells of the storage portion. The collection of the allocated spare cells in the storage device 225 generally make up the spare portion. As such, each storage device 225 in the EOL detection group includes a storage space with at least sub segments referred to as the storage portion and the spare portion.

Method 400 may continue with staggering the size of the spare portion relative to the size of the storage portion across the devices 225 in the EOL detection group such that each device 225 in the EOL detection group has a different ratio of the size of its spare portion to the size of its storage portion (block 408). Here for example, the size of spare portion 304 of device 225a is reduced from a predetermined or recommended size that is associated with ratio 305, 303 of the size of its spare portion 304 to the size of its storage portion 302, the size of spare portion 312 of device 225b is maintained from a predetermined or recommended size that is associated with ratio 309, 311 of the size of its spare portion 312 to the size of its storage portion 308, the size of spare portion 318 of device 225c is increased from a predetermined or recommended size that is associated with ratio 315, 317 of the size of its spare portion 318 to the size of its storage portion 314, and the size of spare portion 324 of device 225d is even further increased from a predetermined or recommended size that is associated with ratio 321, 323 of the size of its spare portion 324 to the size of its storage portion 320. After block 408 each device 225a, 225b, 225c, 225d has a different ratio between the size of its spare portion to the size of its storage portion.

Method 400 may continue with ranking the devices in the EOL detection group from smallest spare size to largest spare size (block 410). For example, storage controller 270 may rank devices in the EOL detection group as (1) storage device 225a because it has the smallest spare portion 304; (2) storage device 225b because it has the next smallest spare portion 312; (3) storage device 225c because it has the next smallest spare portion 318; and (4) storage device 225b because it has the largest spare portion 324.

Method 400 may continue with identifying a benchmark device within the EOL detection group (block 412). For example, storage controller 270 may identify the device 225 which is expected to reach its endurance limit prior to any of the other devices 225 in the EOL detection group. As such, storage controller 270 may select device 225a, in the present example, since device 225a has the smallest spare portion 304.

Method 400 may continue with monitoring the endurance of the benchmark device (block 414) to determine whether the benchmark device reaches its endurance limit (block 416). For example, storage device 225a may systematically report its wear out level, number of P/E cycles, or the like to determine if such device is or has reached its endurance limit. If the benchmark device has not reached its endurance limit, method 400 returns to block 414. The device reaching its endurance limit in block 456 is generally caused or is a result of the storage devices in the EOL detection group storing host data there within.

If the benchmark device has reached its endurance limit, method 400 may continue with recommending that the benchmark storage device be replaced with another storage device (block 420). For example, storage controller 270 may send an instruction to notify an administrator of system 132 that the device 225a has reached its endurance failure point and that it should be replaced. Subsequently, storage controller 270 may receive an instruction input that indicates a new storage device has been added in place of the removed benchmark device. The storage controller 270 may add the newly added device to EOL detection group and it to the end of the ranked list.

Method 400 may continue with determining whether the replaced benchmark device was the last ranked storage device (block 422). For example, if there are no other storage devices ranked lower than the benchmark device that was just replaced then it is determined that the benchmark device that was just replaced was the last benchmark device in the EOL detection group. If there are other storage devices ranked lower than the benchmark device that was just replaced then it is determined that the benchmark device that was just replaced was not the last benchmark device in the EOL detection group. If it is determined that replaced benchmark device was the last ranked storage device at block 422, method 400 may end at block 428.

If not, method 400 may continue with recommending that the next ranked storage device or multiple next ranked storage devices in the ranked list be replaced (block 424). Because the benchmark device has reached its endurance limit the devices that are proximate in ranking to the benchmark device may soon too be approaching their respective endurance limits. As such, if storage device 270 determines that the current endurance level of proximately ranked storage device(s) are within a predetermined threshold to their endurance limits, the storage device 270 may send an instruction to the administrator of the system 132 to replace the proximately ranked storage device(s) as well as the benchmark storage device. For example, if the next two ranked devices 225b, 225c on the ranked list have respective endurance readings that show there are within 5% of their endurance limit, the storage device 270 may send the instruction to the administrator of the system 132 to replace the proximately ranked storage device(s) 224b, 225c as well as the benchmark storage device 225a. Subsequently, storage controller 270 may receive an instruction input that indicates new storage device(s) has been added in place of the proximately ranked device(s). The storage controller 270 may add the newly added device(s) to EOL detection group and it to the end of the ranked list.

Method 400 may continue with identifying the next ranked storage device as the benchmark storage device (block 426) and continue to block 414. As such, the storage device that is next expected to reach end of life is denoted, in block 426, as the benchmark device and is monitored to determine if its endurance limit has been reached in block 414. Method 400 may be performed in parallel or in series for each EOL detection group of devices 225 within the system 132.

By staggering the size of the spare portions in all the devices 225 in the EOL detection group, a fully staggered failure pattern of the storage devices 225 in the EOL detection group is expected. The staggered failure of such devices 225 may allow an administrator to more efficiently manage device 225 replacement with less risk of catastrophic loss of data upon the storage devices 225 in the EOL detection group and less risk of all the storage devices 225 being unavailable for I/O. In other words, each storage device 225 is expected to reach its endurance limit at a different staggered instance compared to the other storage devices 225 in the EOL detection group. This allows an early warning that the other storage devices 225 in the EOL detection group may also soon be reaching their endurance limit.

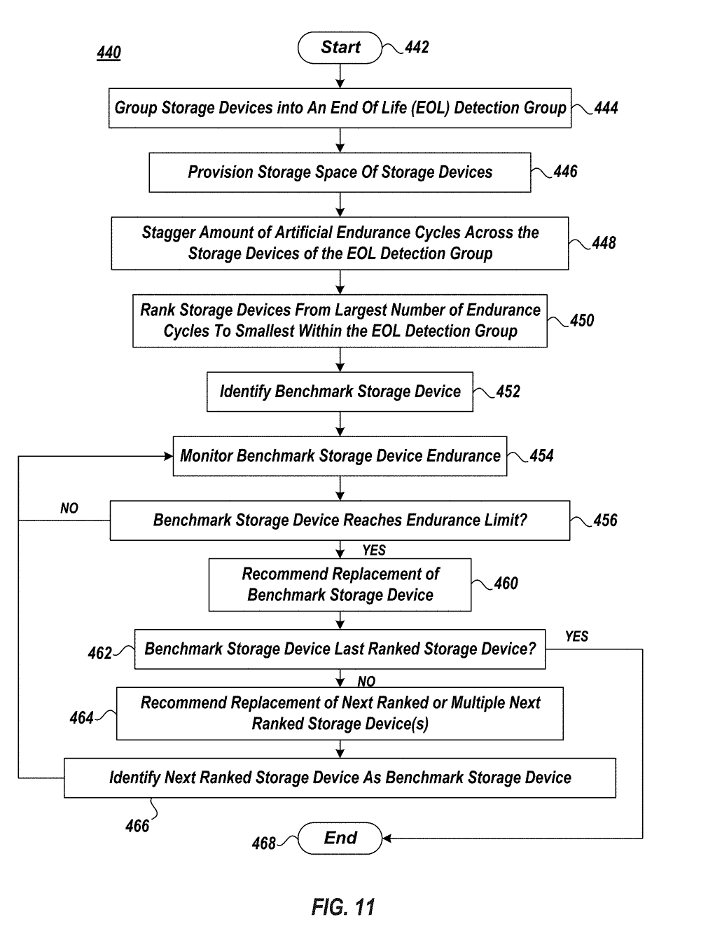

FIG. 11 illustrates an exemplary method 440 of avoiding simultaneous endurance failure of a plurality of write limited storage devices within a storage system by creating a deterministic endurance delta between the storage devices. Method 440 may be utilized by storage controller 270 such that when evoked by processor 201 may cause the storage system 132 to perform the indicated functionality. Method 440 begins at block 442 and continues with grouping multiple storage devices 225 into an EOL detection group (block 444). For example, if there are thirty-two storage devices within system 132, storage controller 270 may create two EOL detection groups of sixteen storage devices 225 each.

Method 440 may continue with provisioning storage space of each storage device (block 446). For example, the controller 270 may provision storage space as the actual physical storage space of a device 225. Within the storage space the controller 270 may provision a storage portion and a spare portion. The storage portion is generally the collection of cells of the storage device 225 that store host data. The controller 270 may allocate spare cells to the spare portion to may be substituted for future failed cells of the storage portion. The collection of the allocated spare cells in the storage device 225 generally make up the spare portion. As such, each storage device 225 in the EOL detection group includes a storage space with at least sub segments referred to as the storage portion and the spare portion.

Method 440 may continue with staggering the number of artificial P/E cycles that each of the devices 225 in the EOL detection group are subject to such that each device 225 in the EOL detection group has a different number of artificial P/E cycles performed therein (block 448). In other words, a detectable endurance limit bias is created between each of the devices 225 in the EOL detection group by changing the number of artificial P/E cycles that each device 225 in the EOL detection group are subject to. For example, a largest number of artificial P/E cycles are performed within storage space 302 of device 225a and a fewer number of largest number of artificial P/E cycles are performed within storage space 308 of device 225b. Similarly, a smallest number of artificial P/E cycles are performed within storage space 320 of device 225d and relatively greater number of artificial P/E cycles are performed within storage space 314 of device 225c. After block 448 each device 225a, 225b, 225c, 225d has had a different number of artificial P/E cycles that is storage portion is subject to.

Method 440 may continue with ranking the devices in the EOL detection group from largest number of artificial P/E cycles to fewest number of artificial P/E cycles (block 450). For example, storage controller 270 may rank devices in the EOL detection group as (1) storage device 225a because it has endured the most artificial P/E cycles; (2) storage device 225b because it has endured the next most artificial P/E cycles; (3) storage device 225c because it has endured the next most artificial P/E cycles; and (4) storage device 225b because it has endured the least artificial P/E cycles.

Method 440 may continue with identifying a benchmark device within the EOL detection group (block 452). For example, storage controller 270 may identify the device 225 which is expected to reach its endurance limit prior to any of the other devices 225 in the EOL detection group. As such, storage controller 270 may select device 225a, in the present example, since device 225a has endured the most artificial P/E cycles.

Method 440 may continue with monitoring the endurance of the benchmark device (block 454) to determine whether the benchmark device reaches its endurance limit (block 456). For example, storage controller 270 may request from storage device 225a its wear out level, number of P/E cycles, or the like to determine if such device is or has reached its endurance limit. If the benchmark device has not reached its endurance limit, method 440 returns to block 454. The device reaching its endurance limit in block 456 is generally caused or is a result of the storage devices in the EOL detection group storing host data there within.

If the benchmark device has reached its endurance limit, method 440 may continue with recommending that the benchmark storage device be replaced with another storage device (block 460). For example, storage controller 270 may send an instruction to notify an administrator of system 132 that the device 225a has reached its endurance limit and that it should be replaced. Subsequently, storage controller 270 may receive an instruction input that indicates a new storage device has been added in place of the removed benchmark device. The storage controller 270 may add the newly added device to EOL detection group and it to the end of the ranked list.

Method 440 may continue with determining whether the replaced benchmark device was the last ranked storage device (block 462). For example, if there are no other storage devices ranked lower than the benchmark device that was just replaced then it is determined that the benchmark device that was just replaced was the last benchmark device in the EOL detection group. If there are other storage devices ranked lower than the benchmark device that was just replaced then it is determined that the benchmark device that was just replaced was not the last benchmark device in the EOL detection group. If it is determined that replaced benchmark device was the last ranked storage device at block 462, method 400 may end at block 468.

If not, method 440 may continue with recommending that the next ranked storage device or multiple next ranked storage devices in the ranked list be replaced (block 464). Because the benchmark device has reached its endurance limit, the devices that are proximate in ranking to the benchmark device may soon too be approaching their respective endurance limits. As such, if storage device 270 determines that the current endurance level of proximately ranked storage device(s) are within a predetermined threshold to their endurance limits, the storage device 270 may send an instruction to the administrator of the system 132 to replace the proximately ranked storage device(s) as well as the benchmark storage device. For example, if the next two ranked devices 225b, 225c on the ranked list have respective endurance readings that show there are within 10% of their endurance limit, the storage device 270 may send the instruction to the administrator of the system 132 to replace the proximately ranked storage device(s) 224b, 225c as well as the benchmark storage device 225a. Subsequently, storage controller 270 may receive an instruction input that indicates new storage device(s) has been added in place of the proximately ranked device(s). The storage controller 270 may add the newly added device(s) to EOL detection group and to the end of the ranked list.

Method 440 may continue with identifying the next ranked storage device as the benchmark storage device (block 466) and continue to block 454. As such, the storage device that is next expected to reach end of life is denoted, in block 466, as the benchmark device and is monitored to determine if its endurance limit has been reached in block 454. Method 440 may be performed in parallel or in series for each EOL detection group of devices 225 within the system 132.

If each of the devices 225a, 225b, 225c, and 225d in the EOL detection group receive the same or substantially the same number of host data writes, the device 225a that had the largest number artificial P/E cycles performed therein results in a fastest exhaustion of that device 225a endurance limit. Similarly, the device 225d that had the smallest number artificial P/E cycles performed therein results in a slowest exhaustion of that device 225d endurance limit. As such, a more staggered failure pattern between the storage devices 225a, 225b, 225c, and 225d in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. By artificially performing a different number of P/E cycles on each of the devices 225, an early cascading warning is created to indicate that another storage device 225 (e.g., the next device with the highest artificial P/E cycles performed thereupon) in the EOL detection group may also soon be reaching their endurance limit or end of life.

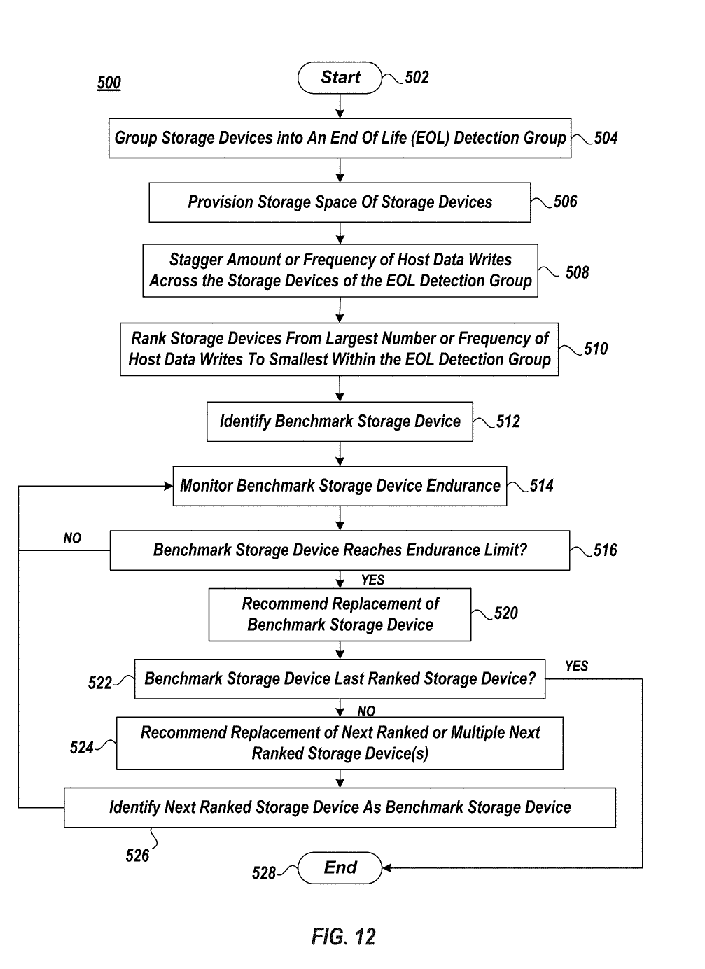

FIG. 12 illustrates an exemplary method 500 of avoiding simultaneous endurance failure of a plurality of write limited storage devices within a storage system by creating a deterministic endurance delta between the storage devices. Method 500 may be utilized by storage controller 270 such that when evoked by processor 201 may cause the storage system 132 to perform the indicated functionality. Method 500 begins at block 502 and continues with grouping multiple storage devices 225 into an EOL detection group (block 504). Method 500 may continue with provisioning storage space of each storage device (block 506). For example, the controller 270 may provision storage space as the actual physical storage space of a device 225. Within the storage space the controller 270 may provision a storage portion and a spare portion. The storage portion is generally the collection of cells of the storage device 225 that store host data. The controller 270 may allocate spare cells to the spare portion to may be substituted for future failed cells of the storage portion. The collection of the allocated spare cells in the storage device 225 generally make up the spare portion. As such, each storage device 225 in the EOL detection group includes a storage space with at least sub segments referred to as the storage portion and the spare portion.

Method 500 may continue with staggering the number or frequency of host data writes to each of the devices 225 in the EOL detection group such that each device 225 in the EOL detection group has a different amount of host data written thereto or has a different frequency of host data writes thereto (block 508). In other words, a detectable endurance limit bias is created between each of the devices 225 in the EOL detection group by changing the number or frequency of host data writes thereto.

For example, storage controller 270 may stagger the number of host writes to devices 225a, 225b, 225c, and 3225d by biasing to which portion 271, 273, 275, or 277 host data is written. For storage controller 270 to prefer device 225a the most, memory controller 204 writes the highest amount of host data to buffer 271. Similarly, for storage controller 270 to prefer device 225b less than device 225a, memory controller 204 may write less host data to buffer 273 relative to the amount of host data it writes to buffer 271. Likewise, for storage controller 270 to prefer device 225c less than device 225b, memory controller 204 may write less host data to buffer 275 relative to the amount of host data it writes to buffer 273. Likewise, for storage controller 270 to prefer device 225d less than device 225c, memory controller 204 may write less host data to buffer 277 relative to the amount of host data it writes to buffer 275.

For example, storage controller 270 may stagger the frequency of host writes to devices 225a, 225b, 225c, and 3225d by staggering the sizes of each portion 271, 273, 275, and 277. Memory controller 204 may allocate a smallest number of memory space or address ranges as portion 271 that serves as a buffer to device 225a; may allocate a larger number of memory space or address ranges, relative to portion 271, as portion 273 that serves as a buffer to device 225b; may allocate a larger number of memory space or address ranges, relative to portion 273, as portion 275 that serves as a buffer to device 225c; and may allocate a larger number of memory space or address ranges, relative to portion 275, as portion 277 that serves as a buffer to device 225d. As such, upon storage controller 270 equally biasing host data writes to each portion 271, 273, 275, and 277, portion 271 fills more rapidly than portions 273, 275, and 277, and the like.

Method 500 may continue with ranking the devices in the EOL detection group from largest number or frequency of host data writes to the lowest number or frequency of host data writes (block 510). For example, storage controller 270 may rank devices in the EOL detection group as (1) storage device 225a because it has endured the most host data writes or because it stores host data the most frequently; (2) storage device 225b because it has endured the next most host data writes or because it stores host data the next most frequently; (3) because it has endured the next most host data writes or because it stores host data the next most frequently; and (4) storage device 225b because it has endured the least host data writes or because it stores host data the least frequently.

Method 500 may continue with identifying a benchmark device within the EOL detection group (block 512). For example, storage controller 270 may identify the device 225 which is expected to reach its endurance limit prior to any of the other devices 225 in the EOL detection group. As such, storage controller 270 may select device 225a, in the present example, since device 225a has endured the most host data writes or because it stores host data the most frequently.

Method 500 may continue with monitoring the endurance of the benchmark device (block 514) to determine whether the benchmark device reaches its endurance limit (block 516). For example, storage controller 270 may request from storage device 225a its wear out level, number of PIE cycles, or the like to determine if such device is or has reached its endurance limit. If the benchmark device has not reached its endurance limit, method 500 returns to block 514. The device reaching its endurance limit in block 516 is generally caused or is a result of the storage devices in the EOL detection group storing host data there within.

If the benchmark device has reached its endurance limit, method 500 may continue with recommending that the benchmark storage device be replaced with another storage device (block 520). For example, storage controller 270 may send an instruction to notify an administrator of system 132 that the device 225a has reached its endurance limit and that it should be replaced. Subsequently, storage controller 270 may receive an instruction input that indicates a new storage device has been added in place of the removed benchmark device. The storage controller 270 may add the newly added device to EOL detection group and it to the end of the ranked list.

Method 500 may continue with determining whether the replaced benchmark device was the last ranked storage device (block 522). For example, if there are no other storage devices ranked lower than the benchmark device that was just replaced then it is determined that the benchmark device that was just replaced was the last benchmark device in the EOL detection group. If there are other storage devices ranked lower than the benchmark device that was just replaced then it is determined that the benchmark device that was just replaced was not the last benchmark device in the EOL detection group. If it is determined that replaced benchmark device was the last ranked storage device at block 522, method 500 may end at block 528.

If not, method 500 may continue with recommending that the next ranked storage device or multiple next ranked storage devices in the ranked list be replaced (block 524). Because the benchmark device has reached its endurance limit, the devices that are proximate in ranking to the benchmark device may soon too be approaching their respective endurance limits. As such, if storage device 270 determines that the current endurance level of proximately ranked storage device(s) are within a predetermined threshold to their endurance limits, the storage device 270 may send an instruction to the administrator of the system 132 to replace the proximately ranked storage device(s) as well as the benchmark storage device. For example, if the next two ranked devices 225b, 225c on the ranked list have respective endurance readings that show there are within 2% of their endurance limit, the storage device 270 may send the instruction to the administrator of the system 132 to replace the proximately ranked storage device(s) 224b, 225c as well as the benchmark storage device 225a. Subsequently, storage controller 270 may receive an instruction input that indicates new storage device(s) has been added in place of the proximately ranked device(s). The storage controller 270 may add the newly added device(s) to EOL detection group and to the end of the ranked list.

Method 500 may continue with identifying the next ranked storage device as the benchmark storage device (block 526) and continue to block 514. As such, the storage device that is next expected to reach end of life is denoted, in block 526, as the benchmark device and is monitored to determine if its endurance limit has been reached in block 514. Method 500 may be performed in parallel or in series for each EOL detection group of devices 225 within the system 132.

The device 225a that had the largest number of or greatest frequency of host data writes results in a fastest exhaustion of that device 225a endurance limit. Similarly, the device 225d that had the smallest number host data writes or least frequency of host data writes performed thereon results in a slowest exhaustion of that device 225d endurance limit. As such, a more staggered failure pattern between the storage devices 225a, 225b, 225c, and 225d in the EOL detection group results. The staggered failure of such devices may allow an administrator to more efficiently manage device 225 replacement with less risk of catastrophic loss of data upon the storage devices 225 in the EOL detection group and less risk of all the storage devices 225 being unavailable for I/O. By staggering the number or frequency of host data writes performed upon each of the devices 225, an early cascading warning is created to indicate that another storage device 225 (e.g., the next device with the highest number of host data writes performed thereupon) in the EOL detection group may also soon be reaching their endurance limit or end of life.

For clarity, method 400, 440, and 450 illustrate different embodiments to create different endurance level(s) between at least one device 225 and the other devices 225 in an EOL detection group. Any one or more these embodiments may be combined as is necessary to create an increased delta of respective endurance level(s) between the at least one device 225 and the other devices 225 in the EOL endurance group. For example, the embodiment of staggering the size of the spare portion in one or more devices 225, associated with method 400 may be combined with the embodiment of allocating a different size of memory portion to one or more devices 225, associated with method 500.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over those found in the marketplace, or to enable others of ordinary skill in the art to understand the embodiments disclosed herein.

What is claimed is:

1. A method of avoiding simultaneous endurance failure of a plurality of write limited storage devices within a storage system, the method comprising:
grouping a plurality of the write limited storage devices into an end of life (EOL) detection group;
provisioning storage space within each of the plurality of write limited storage devices in the EOL detection group such that each provisioned storage space is equal in size and comprises a storage portion that stores host data and a spare portion;
implementing a different endurance exhaustion rate of each write limited storage device by altering a size of each spare portion such that the size of each spare portion is different;
subsequently receiving host data and equally distributing the host data so that each of the plurality of the write limited storage devices in the EOL detection group store an equal amount of host data;
storing the host data that is distributed to each of the plurality of write limited storage devices in the EOL detection group within the respective storage portion of each write limited storage device; and
detecting an endurance failure of the write limited storage device that comprises the smallest spare portion prior to an endurance failure of any other write limited storage devices in the EOL detection group.

2. The method of claim 1, wherein prior to implementing the different endurance exhaustion rate of each write limited storage device by altering the size of each spare portion such that the size of each spare portion is different, all the plurality of write limited storage devices in the EOL detection group comprise a same preset ratio of the spare portion size to the storage portion size.

3. The method of claim 2, wherein altering a size of each spare portion such that the size of each spare portion is different comprises:
decreasing the spare portion size of at least one of the plurality of write limited storage devices in the EOL detection group.

4. The method of claim 1, wherein provisioning storage space within each of the plurality of write limited storage devices in the EOL detection group comprises:
provisioning unavailable storage space within one or more of the plurality of write limited storage devices in the EOL detection group.

5. The method of claim 1, further comprising:
ranking the plurality of write limited storage devices in the EOL detection group in a ranked list from the write limited storage device that comprises the smallest spare portion to the write limited storage device that comprises the largest spare portion.

6. The method of claim 5, further comprising:
subsequent to detecting the endurance failure of the write limited storage device that comprises the smallest spare portion, determining that the endurance failed write limited storage device has been replaced with a replacement write limited storage device; and
adding the replacement write limited storage device to the end of the ranked list.

7. The method of claim 1, further comprising: of the write limited storage devices in the EOL detection group be replaced.

8. A computer program product for avoiding simultaneous endurance failure of a plurality of write limited storage devices within a storage system, the computer program product comprising a computer readable storage medium having program instructions embodied therewith, the program instructions are readable to cause a processor of the storage system to:
group a plurality of the write limited storage devices into an end of life (EOL) detection group;
provision storage space within each of the plurality of write limited storage devices in the EOL detection group such that each provisioned storage space is equal in size and comprises a storage portion that stores host data and a spare portion;
implement a different endurance exhaustion rate of each write limited storage device by altering a size of each spare portion such that the size of each spare portion is different;
subsequently receive host data and equally distribute the host data so that each of the plurality of the write limited storage devices in the EOL detection group store an equal amount of host data;
store the host data that is distributed to each of the plurality of write limited storage devices in the EOL detection group within the respective storage portion of each write limited storage device; and
detect an endurance failure of the write limited storage device that comprises the smallest spare portion prior to an endurance failure of any other write limited storage devices in the EOL detection group.

9. The computer program product of claim 8, wherein prior to implementing the different endurance exhaustion rate of each write limited storage device by altering the size of each spare portion such that the size of each spare portion is different, all the plurality of write limited storage devices in the EOL detection group comprise a same preset ratio of the spare portion size to the storage portion size.

10. The computer program product of claim 9, wherein the program instructions that cause the processor to alter the size of each spare portion such that the size of each spare portion is different further cause the processor to:
decrease the spare portion size of at least one of the plurality of write limited storage devices in the EOL detection group.

11. The computer program product of claim 8, wherein the program instructions that cause the processor to provision storage space within each of the plurality of write limited storage devices in the EOL detection group further cause the processor to:
provision unavailable storage space within one or more of the plurality of write limited storage devices in the EOL detection group.

12. The computer program product of claim 8, wherein the program instructions are readable to further cause the processor to:
rank the plurality of write limited storage devices in the EOL detection group in a ranked list from the write limited storage device that comprises the smallest spare portion to the write limited storage device that comprises the largest spare portion.

13. The computer program product of claim 12, wherein the program instructions are readable to further cause the processor to:
subsequent to detecting the endurance failure of the write limited storage device that comprises the smallest spare portion, determining that the endurance failed write limited storage device has been replaced with a replacement write limited storage device, wherein the replacement write limited storage device has not had any host data writes thereto prior to determining that the endurance failed write limited storage device has been replaced with a replacement write limited storage device; and
adding the replacement write limited storage device to the end of the ranked list.

14. The computer program product of claim 8, wherein the program instructions are readable to further cause the processor to:
upon the detection of the endurance failure of the write limited storage device that comprises the smallest spare portion prior to the endurance failure of any other write limited storage devices in the EOL detection group, recommend that the write limited storage device that comprises the smallest spare portion and at least one other of the write limited storage devices in the EOL detection group be replaced.

15. A storage system comprising a processor communicatively connected to a memory that comprises program instructions that are readable by the processor to cause the storage system to:
group a plurality of the write limited storage devices into an end of life (EOL) detection group;
provision storage space within each of the plurality of write limited storage devices in the EOL detection group such that each provisioned storage space is equal in size and comprises a storage portion that stores host data and a spare portion;
implement a different endurance exhaustion rate of each write limited storage device by altering a size of each spare portion such that the size of each spare portion is different;
subsequently receive host data and equally distribute the host data so that each of the plurality of the write limited storage devices in the EOL detection group store an equal amount of host data;
store the host data that is distributed to each of the plurality of write limited storage devices in the EOL detection group within the respective storage portion of each write limited storage device; and
detect an endurance failure of the write limited storage device that comprises the smallest spare portion prior to an endurance failure of any other write limited storage devices in the EOL detection group.

16. The storage system of claim 15, wherein prior to implementing the different endurance exhaustion rate of each write limited storage device by altering the size of each spare portion such that the size of each spare portion is different, all the plurality of write limited storage devices in the EOL detection group comprise a same preset ratio of the spare portion size to the storage portion size.

17. The storage system of claim 16, wherein the program instructions that cause the processor to alter the size of each spare portion such that the size of each spare portion is different further cause the processor to:
decrease the spare portion size of at least one of the plurality of write limited storage devices in the EOL detection group.

18. The storage system of claim 15, wherein the program instructions that cause the processor to provision storage space within each of the plurality of write limited storage devices in the EOL detection group further cause the processor to: provision unavailable storage space within one or more of the plurality of write limited storage devices in the EOL detection group.

19. The storage system of claim 15, wherein the program instructions are readable by the processor to further cause the storage system to:
rank the plurality of write limited storage devices in the EOL detection group in a ranked list from the write limited storage device that comprises the smallest spare portion to the write limited storage device that comprises the largest spare portion.

20. The storage system of claim 19, wherein the program instructions are readable by the processor to further cause the storage system to:
subsequent to detecting the endurance failure of the write limited storage device that comprises the smallest spare portion, determining that the endurance failed write limited storage device has been replaced with a replacement write limited storage device; and
adding the replacement write limited storage device to the end of the ranked list.
